(19) United States
(12) Patent Application Publication
(10) Pub. No.: US 2023/0151861 A1
(43) Pub. Date: May 18, 2023

(54) ACTUATOR ASSEMBLY FOR A VEHICLE BRAKE AND METHOD FOR MANUFACTURING AN ACTUATOR ASSEMBLY FOR A VEHICLE BRAKE

(71) Applicant: ZF Active Safety GmbH, Koblenz (DE)

(72) Inventors: Volker Knop, Ulmen (DE); Nicholas Alford, Waldesch (DE); Werner Seibert, Kammerforst (DE); Christoph Beuerle, Koblenz (DE); Markus Mallmann, Pfalzfeld (DE)

(21) Appl. No.: 17/987,003

(22) Filed: Nov. 15, 2022

(30) Foreign Application Priority Data
Nov. 17, 2021 (DE) 102021129955.1

(51) Int. Cl. F16D 65/18

(52) U.S. Cl. CPC F16D 65/18; F16D 2121/24

(57) ABSTRACT

An actuator assembly for a vehicle brake is described, which comprises a control assembly, which can be installed as a separate sub-unit and has a partition panel and a circuit board fastened to said partition panel. The actuator assembly furthermore has a drive assembly (14), which can be installed as a separate sub-unit and which comprises a carrier assembly on which an electric motor, a spindle drive and a gear unit are mounted, which gear unit drivingly couples the electric motor and the spindle drive. The control assembly and the drive assembly are arranged in a common housing. A method for manufacturing an actuator assembly for a vehicle brake is furthermore presented.

### CROSS-REFERENCE TO RELATED APPLICATION

This application claims priority to German Priority Application No. 102021129955.1, filed Nov. 17, 2021, the disclosure of which is incorporated herein by reference in its entirety.

### TECHNICAL FIELD

The disclosure relates to an actuator assembly for a vehicle brake. The disclosure is furthermore based on a method for manufacturing an actuator assembly for a vehicle brake.

### BACKGROUND

An actuator assembly in this case serves to move a brake pad of an associated vehicle brake into a braking position in which it is applied to a brake rotor, for example a brake disc, with a certain contact force. hi some cases, actuator assemblies are also used to actively lift the brake pad off the brake rotor and thus transfer it to a rest position.

Given that vehicle brakes and associated actuator assemblies are produced in high quantities, it is important to configure actuator assemblies in such a way that they can be manufactured in a simple and cost-effective manner. Simple and cost-effective installation is particularly important in this case.

### SUMMARY

This is where the disclosure comes in to play. What is needed is to create an actuator assembly which can be manufactured in a particularly simple and cost-effective manner.

Accordingly, an actuator assembly of the type mentioned at the outset is provided, which has a control assembly, which can be installed as a separate sub-unit and which comprises a partition panel and a circuit board fastened to said partition panel. The actuator assembly furthermore has a drive assembly, which can be installed as a separate sub-unit and which comprises a carrier assembly, on which an electric motor, a spindle drive and a gear unit are mounted, which gear unit drivingly couples the electric motor and the spindle drive. In one exemplary arrangement, a driven shaft of the electric motor is aligned substantially perpendicularly to the partition panel and to the circuit board. The control assembly and the drive assembly are arranged in a common housing. In this case, the housing is designed as a sub-unit of the actuator assembly, which sub-unit is separate from the control assembly and the drive assembly. The control assembly and the drive assembly are also mutually separate sub-units. The control assembly, the actuator assembly and the housing can therefore firstly be produced separately from one another, which can take place in parallel. The manufacture of the actuator assembly then only requires the control assembly and the drive assembly to be inserted into the housing. This is comparatively simple and can take place within a short period of time. All in all, the actuator assembly can therefore be manufactured in a very simple, rapid and cost-effective manner. Given that the control assembly is designed to be part of the actuator assembly, the actuator assembly moreover has comparatively few external interfaces. This can therefore be installed in a vehicle with little effort.

In one exemplary arrangement, the electric motor which is present in the actuator assembly is designed as a brushless DC motor. It can be a three-phase motor, Such an electric motor can be operated in an efficient manner. Moreover, it can provide a comparatively high torque relative to its volume. In other words, such an electric motor is compact.

Moreover, respective centre axes of the spindle drive and the electric motor are advantageously arranged in parallel. A compact construction of the drive assembly and therefore the actuator assembly as a whole is thus achieved.

The circuit board of the control assembly is provided with a printed circuit, for example. Alternatively or additionally, electrical and/or electronic components are arranged and electrically contacted on the circuit board.

In one exemplary arrangement, the partition panel of the control assembly is manufactured from plastic material. If the partition panel is provided with edges, it can also be referred to as a partition compartment. The partition compartment may also be manufactured from plastic material.

In one exemplary arrangement, the partition panel is positioned on a side of the control assembly which faces the drive assembly. In the installed state, the partition panel is then located between the drive assembly and the circuit board. It therefore represents a dividing wall between the components of the drive assembly and the components of the control assembly.

Positioning and/or fastening devices for the drive assembly can moreover be provided on the housing. Appropriate devices for positioning and/or fastening the control assembly can also be provided on the housing. Alternatively or additionally, it is possible that the drive assembly comprises devices for positioning and/or fastening the control assembly. The reverse situation is also conceivable, i.e, the control assembly can comprise devices for positioning and/or fastening the drive assembly. A combination of these alternatives is also possible.

The housing can be manufactured from plastic material, at least in part. Such housings can be manufactured in a simple and cost-effective manner, for example using an injection moulding technique.

In one exemplary arrangement, the housing is manufactured entirely from plastic material.

According to one exemplary arrangement, the housing comprises a substantially shell-shaped housing base part and a housing cover which closes the housing base part. Such a construction is structurally simple. Moreover, a housing base part and a housing cover can be manufactured in a simple and cost-effective manner. In this case, the housing cover can also be shell-shaped. Alternatively, the housing cover can be plate-shaped.

In one exemplary arrangement, the housing base part and the housing cover are tightly welded to one another in the installed state. The control assembly and the drive assembly are therefore reliably protected against undesirable environmental influences.

According to one exemplary alternative, a cooling body made of metal is provided on the housing cover, which cooling body contacts at least one electrical or electronic component of the circuit board in a thermally conductive manner. Heat which is generated during operation of the circuit board can thus be reliably dissipated to the environment.

According to another exemplary alternative, the housing cover is manufactured from metal and serves overall as a cooling body. The housing cover is then coupled to at least one electrical or electronic component of the circuit board in a thermally conductive manner so that heat which is generated during operation of the circuit board can be reliably dissipated to the environment via the housing cover.

An arrangement for positioning and fastening the circuit board can be provided on the partition panel. The circuit board can thus be positioned and fastened on the partition panel in a simple and reliable manner. In this case, the positioning comprises both a translatory and a rotational positioning. Centring represents a special type of positioning.

In one exemplary arrangement, retaining ribs for lubricating medium are arranged on a side of the partition panel which faces the drive assembly. In the installed state of the drive assembly and the control assembly, the retaining ribs are adjacent to components of the drive assembly. To enable efficient operation of these components, they can be provided with a lubricating medium, for example lubricating grease. The retaining ribs now have the effect of also keeping the lubricating medium in the region of the associated components during operation of the actuator assembly. This applies in light of the centrifugal forces which occur during operation of the drive assembly. All in all, good reliability and operational safety of the actuator assembly can thus be ensured.

A plug-connector half can also be integrally provided on the housing, wherein the plug-connector half is electrically connected to the circuit board via at least a first electric line. In this case, describing the line as a “first” line merely serves for simple explanation. A number of lines is not implied. The plug-connector half can be designed to supply the actuator assembly with electric energy. Alternatively or additionally, it is conceivable for the actuator assembly to be connected to a bus system, e.g, a CAN bus system, via the plug-connector half. It is also possible to couple a wheel speed sensor to the actuator assembly via the plug-connector half, which wheel speed sensor is associated with a wheel to be braked. The actuator assembly is therefore reliably supplied with the required energy and the signals which are required for operation.

In one exemplary arrangement, the components of the plug-connector half are integrated at least partially in the housing. In this case, the components of the plug-connector half can be pressed into the housing or overmoulded with portions of the housing. Both variants can be produced in a technically simple manner.

In this case, it is possible for the first electric line to be integrated in the housing, at least in part, wherein a portion of the first electric line which is on the circuit-board side extends substantially parallel to the driven shaft of the electric motor. The first electric line is injection moulded into the housing, for example. The installation of the actuator assembly is thus very simple.

In one exemplary arrangement, the first electric line is dimensionally stable. This applies especially to the portion thereof which is on the circuit-board side. Contacting of the circuit board is therefore possible via a press connection or an insulation displacement connection. The electrical contacting therefore involves little effort.

The electric motor and the circuit board can be electrically connected via a second electric line, wherein the second electric line extends substantially parallel to the driven shaft of the electric motor. This results in a comparatively short second electric line. A structurally simple construction of the actuator assembly is thus achieved.

In one exemplary arrangement the second electric line is also dimensionally stable. The effects and advantages achieved are the same as those which have already been explained with respect to the first electric line.

Moreover, the partition panel and the circuit board can be connected via a potting material, at least in part. Electric lines provided on the circuit board as well as electrical and/or electronic components can thus be protected against environmental influences. This applies especially to vibrations and moisture. In one exemplary arrangement, the potting material is introduced into the subassembly comprising the circuit board and the partition panel before said subassembly is installed in the housing.

Moreover, passages, which are delimited by edges, can be provided on the partition panel, wherein the edges serve to keep the passages free of potting material. In this case, passages for the first electric line and/or the second electric line are provided with such edges, for example.

The control assembly can comprise a speed regulating unit for regulating a speed of the electric motor and/or a current measuring unit for measuring a current received by the electric motor and/or a current supply unit for supplying the electric motor with electric energy and/or a temperature measuring unit for measuring a temperature within the actuator assembly and/or a force measuring unit for measuring a brake actuating force provided by the actuator assembly and/or a rotational position detection unit for detecting a rotational position of the electric motor and/or an actuating unit for a locking assembly for blocking the driven shaft of the electric motor against rotation. In this connection, the power supply unit can also be referred to as power electronics. All in all, numerous electrical or electronic type functionalities are provided directly in the actuator assembly. In this connection, it is also possible to refer to these functions as being decentralised or locally available. Installation of the actuator assembly is thus simplified, since the number of external interfaces is comparatively small.

In one alternative arrangement, a magnet is arranged on an end of the driven shaft of the electric motor which faces the control assembly. A sensor which is associated with the magnet is positioned on the circuit board such that it is substantially opposite the end of the driven shaft. Accordingly, the magnet can also be referred to as a sensor magnet. In one exemplary arrangement, the magnet is a permanent magnet. The sensor is for example a Hall sensor or an inductive sensor. In both alternatives, a rotational position of the driven shaft of the electric motor can be determined by the magnet and the sensor. If associated sensor signals are evaluated over time, motor revolutions can also be detected. Both alternatives are simple and serve for reliable operation of the actuator assembly.

In this case, it is possible to deduce a spindle nut travel and a spindle nut position of a spindle nut of the spindle drive on the basis of the revolutions of the driven shaft of the electric motor, since there is a constant relationship between the revolutions of the electric motor and the spindle nut travel. With knowledge of the system rigidity of the actuator assembly, and depending on the associated brake pad thickness and the temperature, the value of an application force for the vehicle brake which is currently being generated by the actuator assembly can furthermore be determined using the spindle nut travel or the spindle nut position.

By measuring a current consumption of the electric motor, it is also possible to deduce the currently generated motor torque. From this, it is possible to derive the torque introduced into the spindle drive and, in turn, the application force, since the transmission ratios are constant and only the current level of efficiency needs to be evaluated.

In a further alternative arrangement, the application force can be measured by an integrated force sensor.

In a situation in which there are two more measurement values for the application force, these can be compared for the purpose of fault detection. In this case, for example, a fault situation can be deduced if the measurement values deviate from one another by more than a specified amount or more than a specified percentage.

A method for manufacturing an actuator assembly for a vehicle brake, comprising the following steps is also disclosed:

a) providing a substantially shell-shaped housing base part,

b) inserting a drive assembly into the housing base part, which drive assembly comprises a carrier assembly on which an electric motor, a spindle drive and a gear unit are mounted, which gear unit drivingly couples the electric motor and the spindle drive.

c) inserting a control assembly into the housing base part, which control assembly comprises a partition panel and a circuit board fastened to said partition panel, wherein the insertion results in an electrical connection of at least the electric motor and the circuit board, and

d) closing the housing base part with a housing cover.

Such a method is structurally simple and can therefore be implemented in a rapid and cost-effective manner. In this connection, the driven shaft of the electric motor is again aligned substantially perpendicularly to the partition panel and to the circuit board.

Moreover, a plug-connector half can be integrally provided on the housing and the plug-connector half can be electrically connected to the circuit as a result of inserting the control assembly into the housing base part. This takes place without additional effort during the insertion of the control assembly.

In one exemplary arrangement, the circuit board is electrically connected to the electric motor and/or the plug-connector half by forming an electrical press connection or an electrical insulation displacement connection. The electrical contacting therefore takes place without further activity during the insertion of the corresponding assembly. Therefore, the electrical contacting does not require additional effort.

### BRIEF DESCRIPTION OF DRAWINGS

The disclosure is explained below with reference to an exemplary arrangement, which is shown in the accompanying drawings, in which:

FIG. 1 shows an exemplary actuator assembly, which has been manufactured by a method for manufacturing an actuator assembly, in a perspective exploded illustration,

FIG. 2 shows a drive assembly of the actuator assembly of FIG. 1 in an isolated, partially sectional illustration,

FIG. 3 shows the actuator assembly of FIG. 1 in a sectional view in the plane III of FIG. 1, wherein a brake calliper assembly is connected to the actuator assembly,

FIG. 4 shows the actuator assembly of FIG. 3 in a view along the section line IV-IV, wherein a spindle drive of the actuator assembly is not illustrated,

FIG. 5 shows a carrier assembly of the drive assembly of FIG. 2 in a perspective exploded illustration,

FIG. 6 shows the drive assembly of FIG. 2 in a rear view, wherein a spindle drive is not illustrated,

FIG. 7 shows a detailed view of a locking assembly of the actuator assembly of FIGS. 1 to 6, wherein the locking assembly assumes a locking state,

FIG. 8 shows a detailed view, corresponding to FIG. 7, of the locking assembly, wherein the locking assembly assumes a release state,

FIG. 9 shows a control assembly of the actuator assembly of FIG. 1 in a perspective exploded illustration, and

FIG. 10 shows the control assembly of FIG. 9 in a view along the direction X in FIG. 9.

### DETAILED DESCRIPTION

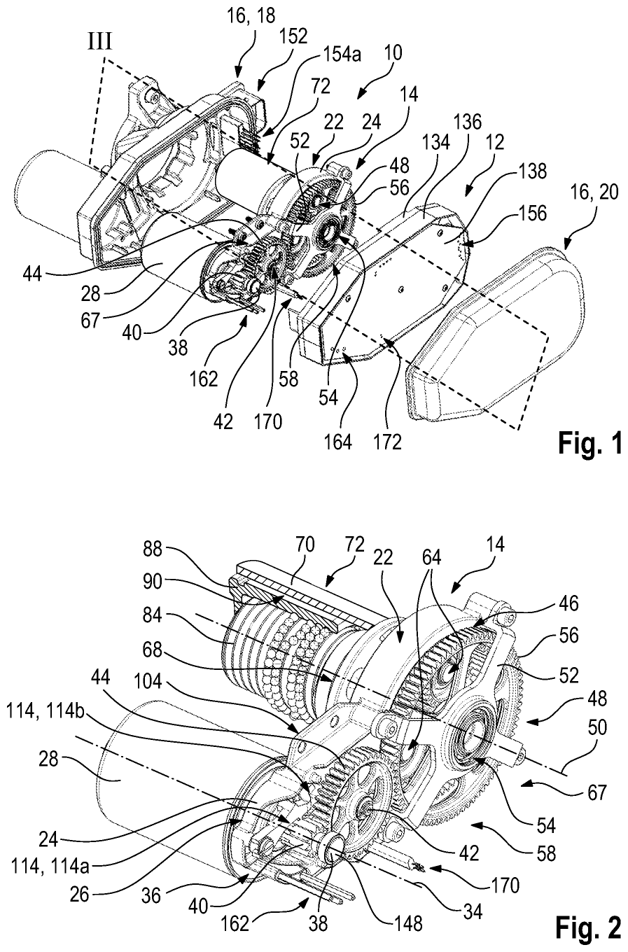

FIG. 1 shows an actuator assembly 10 for a vehicle brake.

The actuator assembly 10 comprises a control assembly 12, which can be installed as a separate sub-unit, and a drive assembly 14, which can be installed as a separate sub-unit.

The control assembly 12 and the drive assembly 14 are arranged in a common housing 16.

The housing 16 comprises a substantially shell-shaped housing base part 18 and a housing cover 20, by which the housing base part 18 is tightly dosed in the installed state.

In the illustrated exemplary arrangement, the housing cover 20 is also substantially shell-shaped.

Both the housing base part 18 and the housing cover 20 are manufactured from plastic material. The housing 16 in its entirety is therefore made of plastic material.

The drive assembly 14 can be seen in detail in FIGS. 2 to 6.

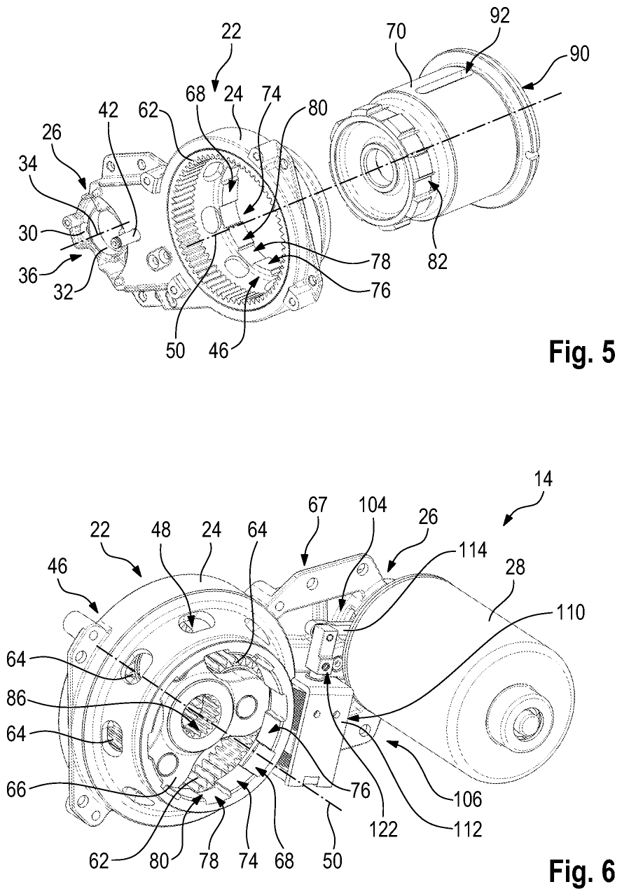

The drive assembly 14 comprises a carrier assembly 22, which has a plate-shaped frame part 24 (see for example FIGS. 2 and 5).

A first fastening interface 26, to which an electric motor 28 is fastened in the illustrated exemplary arrangement, is provided on the plate-shaped frame part 24.

For example, the electric motor 28 is connected to the frame part 24 in a captive manner via the first fastening interface 26. To this end, a bore 30, via which the electric motor 28 can be fastened to the frame part 24 by a fastener, such as a screw (see FIGS. 4 and 5), is provided on the frame part 24.

Moreover, a centring device 32 in the form of a centring surface is arranged on the frame part 24. The electric motor 28 can therefore be fastened to the frame part 24 in a centred manner with respect to a centre axis 34 of the first fastening interface 26.

Moreover, an anti-rotation device 36 in the form of an anti-rotation depression is provided, which is designed to prevent the electric motor 28 from rotating with respect to the frame part 24.

To introduce a torque into the drive assembly 14, a driven gearwheel 40 is arranged on a driven shaft 38 of the electric motor 28.

A bearing pin 42 is moreover provided on the frame part 24, on which bearing pin a gearwheel 44, which meshes with the driven gearwheel 40, is mounted in the illustrated exemplary arrangement.

Moreover, a receiving space 46 for a planetary gear stage 48 is provided on the frame part 24. In the illustrated exemplary arrangement, the receiving space 46 is substantially bell-shaped (see in particular FIG. 5).

In this case, a centre axis 50 of the receiving space 46 is arranged substantially parallel to the centre axis 34 of the first fastening interface 26.

A reinforcing part 52 is furthermore fastened to the frame part 24 in such a way that it spans the receiving space 46 at the axial end face with respect to the centre axis 50.

In the illustrated exemplary arrangement, the reinforcing part 52 is substantially cross-shaped.

A bearing point 54 for a gearwheel 56 is moreover provided on the reinforcing part 52, which gearwheel is arranged coaxially to the planetary gear stage 48.

The gearwheel 56 meshes with the gearwheel 44.

A gear train 58 is thus formed by the gearwheel 44 and the gearwheel 56, as the input element of said gear train operates the driven gearwheel 40.

The gearwheel 56 is furthermore formed in one piece with a sun wheel 60 of the planetary gear stage 48. The gear train 58 and the planetary gear stage 48 are thus drivingly coupled.

The planetary gear stage 48 moreover comprises a ring gear 62, which extends substantially along an inner circumference of the receiving space 46 (see for example FIG. 5).

In the illustrated exemplary arrangement, a total of three planetary gears 64 are drivingly provided between the sun wheel 60 and the ring gear 62. These planetary gears are rotatably mounted on a planetary carrier 66.

In this case, the planetary carrier 66 represents a driven element of the planetary gear stage 48.

The gear train 58 and the planetary gear stage 48 are also referred to collectively as a gear unit 67.

The frame part 24 moreover has a second fastening interface 68, which is designed for fastening a bearing sleeve 70 for a spindle drive 72.

In this case, a centre axis of the second fastening interface 68 coincides with the centre axis 50 of the receiving space 46 and is therefore denoted by the same reference sign.

The second fastening interface 68 has an anti-rotation geometry 74, which extends circumferentially around the centre axis 50 and is formed by a plurality of radial projections 76 and radial depressions 78 arranged circumferentially in an alternating manner. For better clarity, only one exemplary radial projection 76 and one exemplary radial depression 78 are denoted by a reference sign in each case in FIGS. 5 and 6.

The radial projections 76 and the radial depressions 78 are provided at a constant spacing. This means that the radial depressions 78 each have the same length in the circumferential direction. The radial projections 76 also each have the same length in the circumferential direction. A radial height of the radial projections 76 is moreover constant.

An anti-rotation device 80 of the second fastening interface 68 is thus formed.

On that end of the bearing sleeve 70 which is to be coupled to the second fastening interface 68, a complementary geometry 82 is provided so that the bearing sleeve 70 can be inserted into the anti-rotation geometry 74 of the second fastening interface 68 along the centre axis 50 and is held therein in a torsion-resistant manner.

The spindle drive 72 is received in the interior of the bearing sleeve 70.

This spindle drive comprises a spindle 84, which, in the present exemplary arrangement, is configured as a ball screw (see for example FIG. 2).

In this case, the spindle 84 is connected to the planetary carrier 66 in a torsion-resistant manner via the toothed portion 86.

The spindle drive 72 can therefore be driven by the electric motor 28. In detail, the electric motor 28 is drivingly coupled to the spindle drive 72 via the gear train 58 and the planetary gear stage 48.

A spindle nut 88, which is configured in the shape of a piston, is mounted on the spindle 84. In this case, a rotation of the spindle 84 brings about an axial displacement of the spindle nut 88 along the centre axis 50.

In this case, the spindle nut 88 is guided along the centre axis 50 via a linear guiding geometry 90 on the bearing sleeve 70. The linear guiding geometry 90 corresponds substantially to a cylinder lateral surface which forms the inner circumference of the bearing sleeve 70.

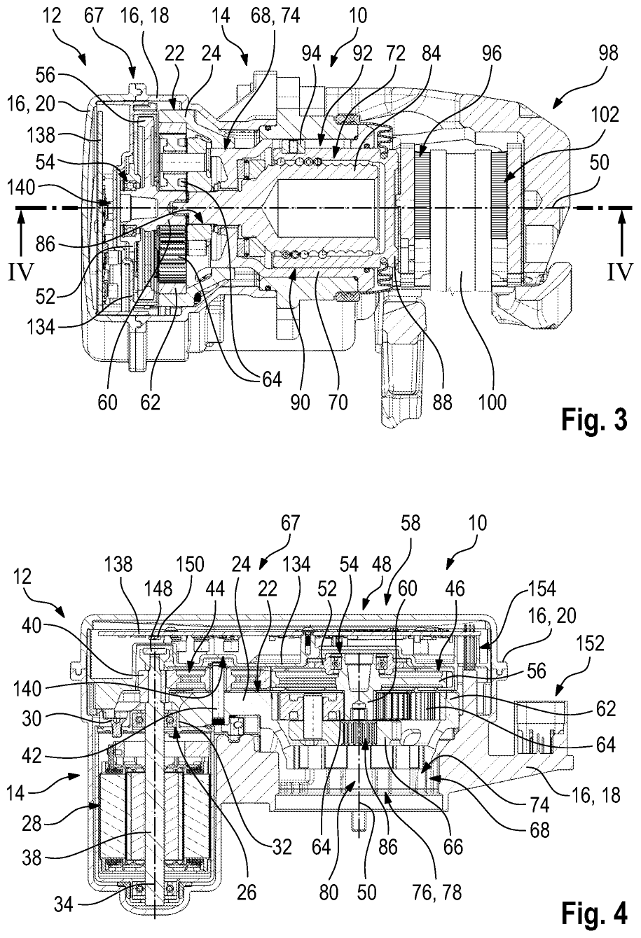

The spindle nut 88 is furthermore prevented from performing a relative rotation around the centre axis 50 by an anti-rotation device 92, which is designed as an elongated hole in the bearing sleeve 70. To this end, a radial projection 94 is attached to the spindle nut 88, which radial projection engages in the elongated hole (see FIG. 3).

The spindle nut 88 moreover serves as an actuating slide for a first brake pad 96 of a brake calliper assembly 98 (see FIG. 3). Since the spindle nut 88 and the actuating slide are formed by the same component, they are denoted by the same reference sign.

The first brake pad 96 can therefore be actively moved towards a brake rotor 100 by the actuator assembly 10, which brake rotor is designed as a brake disc in the illustrated exemplary arrangement.

In detail, by the electric motor 28, the actuating slide 88 is optionally transferred to an extended position via the gear train 58, the planetary gear stage 48 and the spindle drive 72, which extended position is associated with the first brake pad 96 being applied to the brake rotor 100.

Owing to the reaction forces acting within the actuator assembly 100 and the brake calliper assembly 98, a second brake pad 102 is thus also applied to the brake rotor 100 (again, see FIG. 3).

It goes without saying that, through the operation of the electric motor 28, the actuating slide 88 can be moved into a retracted position in the same way, which retracted position is associated with the first brake pad 96 and the second brake pad 102 being lifted off the brake rotor 100.

In the present exemplary arrangement, however, the actuating assembly 10 is designed without self-locking, so that the actuating slide 88, owing to the elasticities inherent to the system, is also automatically moved back into the retracted position when it is no longer actively forced into the extended position by the electric motor 28.

A third fastening interface 104 is moreover provided on the frame part 24 (see for example FIG. 6).

This fastening interface is designed for fastening a locking assembly 106, wherein the locking assembly 106 is in turn provided for optionally blocking the driven shaft 38 of the electric motor 28 in terms of rotation.

In this connection, the third fastening interface 104 comprises a bearing pin 108 fastened to the frame part 24 and a fastening interface 110 for a locking actuator 112.

The locking assembly 106 is equipped with a locking lever 114, which has a first, forked end 116, which receives the bearing pin 108 for rotatably mounting the locking lever 114.

The locking lever 114 is therefore rotatably mounted on the carrier assembly 22, and more precisely on the frame part 24, at its first end 116.

At a second, opposite end 118 of the locking lever 114, this is coupled to the locking actuator 112 via an elongated hole 120.

In the illustrated exemplary arrangement, the locking actuator 112 is designed as a bistable lifting magnet.

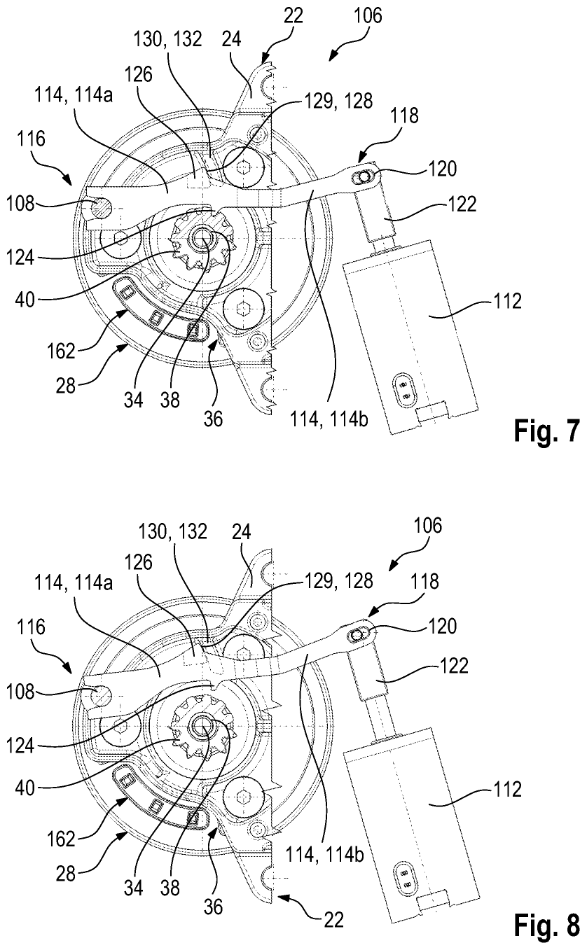

This means that an armature 122 of the locking actuator 112 can be held both in its extended position and in its retracted position in the de-energised state (see FIGS. 7 and 8). The locking actuator 112 only needs to be energised to move the armature 122 between these two positions.

A locking tooth 124 is furthermore positioned between the first end 116 and the second end 118 as seen in a direction along the longitudinal extent of the locking lever 114.

This locking tooth is formed in one piece with the locking lever 114.

The toothing of the driven gearwheel 40 moreover acts as a locking contour.

The locking tooth 124 can therefore be optionally brought into engagement with the locking contour through the actuation of the locking actuator 112.

If the locking tooth 124 therefore engages in the driven gearwheel 40, the electric motor 28 is therefore blocked in terms of rotation (see FIG. 7). Such a position of the locking assembly 106 is also referred to as a locking position or locking state.

If the locking tooth 124 is located outside the toothing of the driven gearwheel 40, this gearwheel can be freely rotated. Such a position of the locking assembly 106 is referred to as a release position (see FIG. 8).

The locking lever 114 furthermore has a supporting projection 126 in the direction along its longitudinal extent between the first end 116 and the second end 118, the flank 128 of which supporting projection forms a supporting contour 129.

The supporting projection 126 is also formed in one piece on the locking lever 114.

In this case, the flank 128 lies against a bearing contour 132, which is formed as an arcuate wall portion 130 of the frame part 24, i.e. of the carrier assembly 22, in a substantially radial direction with respect to the bearing pin 108.

In this case, a lateral surface of the arcuate wall portion 130, which faces the flank 128, is designed as a lateral cylinder surface portion of a circular cylinder, whereof the centre axis coincides with a centre axis of the bearing pin 108.

The flank 128 is likewise designed as a lateral cylinder surface portion of such a circular cylinder.

By way of the supporting projection 126 and the bearing contour 132, the locking lever 114 is therefore supported on the frame part 24, i.e. on the carrier assembly, against forces which act substantially radially with respect to the rotational bearing of the locking lever 114 around the bearing pin 108.

In the locking state, such force components result from a torque which is applied to the driven gearwheel 40, for example.

The bearing contour 132 can therefore also be regarded as part of the third fastening interface 104.

To enable its engagement in the driven gearwheel 40 for the purpose of blocking a rotational movement of the electric motor 28 without simultaneously obstructing a meshing between the driven gearwheel 40 and the gearwheel 44, the locking lever 114 has a first portion 114a in the direction along its longitudinal extent, which portion comprises the first end 116. A second portion 114b comprises the second end 118.

In this case, the second portion 114b is offset relative to the first portion 114a along the centre axis 34 in the direction of the electric motor 28. It may also be said that the locking lever 114 has a headless design.

It is thus possible that the second portion 114b extends behind the gearwheel 44 as seen in the axial direction.

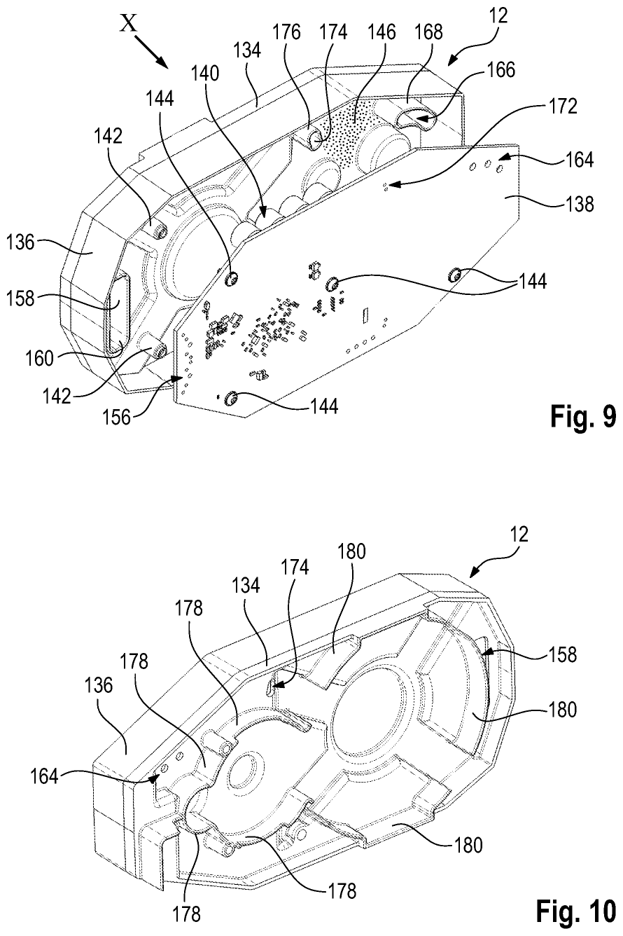

FIGS. 9 and 10 show the control assembly 12 in detail.

This control assembly comprises a partition panel 134 which, in the illustrated exemplary arrangement, is provided with an edge 136 which extends substantially entirely along an outer circumference of the partition panel 134.

The partition panel 134 can therefore also be referred to as a partition compartment.

The control assembly 12 furthermore comprises a circuit board 138 on which electrical and electronic components (denoted as a whole by 140) are arranged and electrically connected to one another via traces.

In this case, the electrical and electronic components 140 form a speed regulating unit for regulating a speed of the electric motor 28.

The electrical and electronic components 140 furthermore form a current measuring unit for measuring a current received by the electric motor 28.

The electrical and electronic components 140 moreover represent a current supply unit for supplying the electric motor 28 with electric energy. In this connection, the electrical and electronic components 140 can also be referred to as power electronics.

Moreover, the electrical and electronic components 140 form a temperature measuring unit for measuring a temperature within the actuator assembly 10.

A force measuring unit for measuring a brake actuating force provided by the actuator assembly is also created by the electrical and electronic components 140.

The electrical and electronic components 140 furthermore represent an actuating unit for the locking assembly 106.

In addition, a rotational position detection unit for detecting a rotational position of the electric motor 28 is formed by the electrical and electronic components 140, which rotational position detection unit is explained in detail below.

In order to fasten the partition panel 134 and the circuit board 138 to one another in a predetermined relative position, a positioning and fastening arrangement 142 for the circuit board 138 are provided on the partition panel 134.

In the exemplary arrangement illustrated in FIG. 9, the positioning and fastening arrangement 142 is formed by fastening domes, which are arranged on the partition panel 134 and into which screws 144, which pass through the circuit board 138, are screwed.

Moreover, the partition panel 134 and the circuit board 139 are connected to one another via a potting material 146, which is illustrated merely schematically in an exemplary region. In one exemplary arrangement, a clearance which is present between the partition panel 134 and the circuit board 138 is filled substantially entirely with the potting material 146. The electrical and electronic components 140 are thus protected against undesirable external influences, for example against vibrations and moisture.

The partition panel 134 and the circuit board 138 are arranged relative to the electric motor 28 such that the driven shaft 38 of the electric motor 28 is aligned perpendicularly to the partition panel 134 and to the circuit board 138.

In this case, a magnet 148 is arranged at an end of the driven shaft 38 of the electric motor 28 which faces the control assembly 12 (see in particular FIGS. 2 and 4).

An associated sensor 150 is positioned on the circuit board 138 at a point which is opposite the magnet 148 (see in particular FIG. 4).

In the illustrated exemplary arrangement, the sensor 150 is designed as a Hall sensor. A rotational position of the driven shaft 38 of the electric motor 28 can thus be detected. When evaluating the rotational position signals over time, revolutions of the driven shaft 38 can also be determined.

In order to supply the control assembly 12 and in particular the electrical and electronic components 140 with electric energy, a plug-connector half 152 is integrally provided on the housing 16, and more precisely on the housing base part 18 (see FIGS. 1 and 4).

In this case, the plug-connector half 152 is electrically connected to the circuit board 138 via a plurality of lines which are collectively referred to as the first electric line 154.

Starting from the plug-connector half 152, the first electric line 154 firstly extends within the housing base part 18. In this connection, the first electric line 154 can already be integrated in the housing base part 18 during the manufacture thereof.

In this case, a portion 154a of the first electric line 154 which is on the circuit-board side is designed to be dimensionally stable and protrudes from the housing base part 18 in a direction which is aligned substantially parallel to the centre axes 34 and 50.

Contact openings 156 associated with the first electric line 154 are provided on the circuit board 138.

A passage 158 is furthermore formed on the partition panel 134 so as to ensure that the portion 154a which is on the circuit-board side reaches the circuit board 138 without making contact with the partition panel 134.

The passage 158 is moreover provided with an edge 160 so that the passage 158 is kept free of potting material 146.

The first electric line 154, and more precisely the portion 154a thereof which is on the circuit-board side, can therefore be plugged into the associated contact openings 156 during the installation of the control assembly 12 on the housing base part 18. In this case, they form an electrical press contact.

In the illustrated exemplary arrangement, the plug-connector half 152 serves not only for supplying power, but also for connecting the actuator assembly 10 to a bus system, which is for example a CAN bus system.

Wheel speed sensors can furthermore be connected to the actuator assembly 10 via the plug-connector half 152.

The electric motor 28 is also electrically connected to the circuit board 138.

To this end, dimensionally stable contacts protrude from the electric motor 28 such that they are substantially parallel to the centre axis 34, which contacts are collectively referred to as the second electric line 162.

Contact openings 164 in the circuit board 138 are likewise associated with the second electric line 162.

A passage 166 is furthermore provided on the partition panel 134, through which passage the second electric line 162 can come into engagement with the contact openings 164.

The passage 166 is again equipped with an edge 168, so as to ensure that the passage 166 is kept free of potting material 146.

As has already been explained with respect to the first electric line 154, the second electric line 162 also enters the associated contact openings 164 during the installation of the control assembly 12 and forms an electrical press contact.

The locking actuator 112 is electrically connected to the circuit board 138 via a third electric line 170 (see FIGS. 1 and 2).

In this case, the third electric line 170 is also again formed by dimensionally stable contacts, which protrude from the locking actuator 112 along the centre axes 34 and 50.

Contact openings 172 in the circuit board 138 are again associated with the third electric line 170 (see FIG. 9).

So that the third electric line 170 can be plugged into the contact openings 172, a passage 174 is moreover provided on the partition panel 134. This passage is equipped with an edge 176 so that the passage 174 is also kept free of potting material 146.

As already explained with respect to the first electric line 154 and the second electric line 162. the third electric line 170 is also inserted into the associated contact openings 172 during the installation of the control assembly 12 and forms an electrical press contact.

In summary, the circuit board 138 is therefore electrically coupled to the plug-connector half 152 as well as to the electric motor 28 and the locking actuator 112.

On a side of the partition panel 134 which faces the drive assembly 14, retaining ribs 178 are moreover provided in the region of the driven gearwheel 40 and the gearwheel 44, which retaining ribs substantially form an enveloping end around a gear stage which is formed by the driven gearwheel 40 and the gearwheel 40.

Retaining ribs 180 are also provided in the region of the planetary gear stage 48.

In this case, the retaining ribs 178, 180 serve to keep a lubricating medium in the region of the gearwheels to be lubricated, even upon a rotation of the driven gearwheel 40, the gearwheel 44 and the planetary gear stage 48.

By the actuator assembly 10, a service brake function can be provided when the actuator assembly 10 is coupled to the brake calliper assembly 98. The actuator assembly 10 is then operated in service brake mode. In this case, the electric motor 28 is controlled by the control assembly 12 in such a way that it brings about a desired displacement of the spindle nut 88—the actuating slide 88—along the centre axis 50 via the gear train 58, the planetary gear stage 48 and the spindle drive 72.

In this case, the electric motor 28 can fundamentally be actuated in both directions of rotation so that the actuating slide 88 can also be actively displaced in both directions.

It is likewise conceivable to only use the electric motor 28 to move the actuating slide 88 into an extended position, i.e. to apply the brake pad 96 to the brake rotor 100.

In this connection, the actuating slide 88 can be restored to a retracted position, i.e. the pressure on the brake pad 96 can be relieved, as a result of the elasticities which are inherent to the system on the one hand and the non-self-locking configuration of the actuator assembly 10 on the other.

In such an operating mode, the locking assembly 106 always assumes the release state (see FIG. 8).

Moreover, a parking brake function can be provided by the actuator assembly 10.

In this connection, a parking brake mode can be activated in that the spindle nut 88 (which forms the actuating slide 88) is transferred to its extended position by the electric motor 28 and the brake pad 96 is therefore applied to the brake rotor 100. In this case, the brake pad 102 is also applied to the brake rotor 100 as a result of reaction forces which act within the actuator assembly 10.

Finally, the locking assembly 106 is transferred to the locking state by the locking actuator 112 (see FIG. 7).

Up to the point at which the locking tooth 124 actually engages in the toothing of the driven gearwheel 40 and therefore locks a rotation of the driven shaft 38, the spindle nut 88 (which forms the actuating slide 88) is actively held in the extended position by the electric motor 28, i.e. the electric motor 28 is energized accordingly.

A current supply to the electric motor 28 is only interrupted when the locking tooth 124 securely engages in the locking contour formed by the toothing of the driven gearwheel 40.

There are a plurality of alternatives for deactivating the parking brake mode.

To this end, in one exemplary alternative, the electric motor 28 is actuated in a direction in which it forces the spindle nut 88 (which forms the actuating slide 88) into the extended position, i.e. it moves it in the direction of the brake pad 96.

This relieves the force on the locking lever 114.

The locking lever 114 can therefore be easily transferred from the locking position to the release position by the locking actuator 112 (see FIGS. 7 and 8)

The energization of the electric motor 28 can then be stopped so that the spindle nut 88 automatically moves back into the retracted position due to the lack of a self-locking effect.

It is alternatively conceivable that, rather than the locking lever 114 being transferred to the release position as a result of an actuation of the locking actuator 112, the electric motor 28 is instead actuated in a direction which corresponds to the extended position of the spindle nut 88 in such a way that the locking lever 114 is forced into its release position by the electric motor 28.

The electric motor 28 can then be operated in a direction which is associated with the retracted position of the spindle nut 88 so that the parking brake mode is deactivated.

It goes without saying that it is also conceivable for the parking brake mode to be deactivated merely by actuating the locking lever 114 by the locking actuator 112. In this alternative, the electric motor 28 is not used to deactivate the parking brake mode. However, the locking lever 144 may have to be switched under load.

The actuator assembly 10 can be manufactured as follows.

Firstly, the housing base part 18 is provided.

Then, the already pre-assembled drive assembly 14 is inserted into the housing base part 18.

As already explained, the drive assembly 14 comprises the carrier assembly 22, on which the electric motor 28, the spindle drive 72 and the gear unit 67 is mounted, which gear unit drivingly couples the electric motor 28 and the spindle drive 72 and comprises the clear train 58 and the planetary gear stage 48.

The control assembly 12 is then inserted into the housing base part 18.

As already explained, the control assembly 12 comprises the partition panel 134 and the circuit board 138.

As a result of inserting the control assembly 12 into the housing base part 18, the electric motor 28 is moreover electrically connected to the circuit board via the second electric line 162.

The plug-connector half 152 is furthermore electrically connected to the circuit board 138 via the first electric line 154.

The locking actuator 112 is also connected to the circuit board 138 via the third electric line 170 during the insertion of the control assembly 12.

In this case, the electrical connections are each formed in that the electric lines 154, 162, 170 are plugged into the respectively associated contact openings 156, 164, 172 to form an electrical press contact.

The housing base part 18 is finally closed by fitting the housing cover 20.

1. An actuator assembly for a vehicle brake, comprising:
a control assembly, which can be installed as a separate sub-unit and which comprises a partition panel and a circuit board which is fastened to said partition panel, and having
a drive assembly, which can be installed as a separate sub-unit and which comprises a carrier assembly on which an electric motor, a spindle drive and a gear unit are mounted, which gear unit drivingly couples the electric motor and the spindle drive, wherein a driven shaft of the electric motor is aligned substantially perpendicularly to the partition panel and to the circuit board;
wherein the control assembly and the drive assembly are arranged in a common housing.

2. The actuator assembly according to claim 1, wherein the housing is manufactured from plastic material, at least in part.

3. The actuator assembly according to claim 1, wherein the housing comprises a substantially shell-shaped housing base part and a housing cover which closes the housing base part.

4. The actuator assembly according to claim 1, wherein a positioning and fastening arrangement for the circuit board is provided on the partition panel.

5. The actuator assembly according to claim 1, wherein retaining ribs for a lubricating medium are arranged on a side of the partition panel which faces the drive assembly.

6. The actuator assembly according to claim 1, wherein a plug-connector half is integrally provided on the housing, wherein the plug-connector half is electrically connected to the circuit board via at least a first electric line.

7. The actuator assembly according to claim 6, wherein the first electric line is integrated in the housing, at least in part, wherein a portion of the first electric line which is on a circuit board-side extends substantially parallel to the driven shaft of the electric motor.

8. The actuator assembly according to claim 1, wherein the electric motor and the circuit board are electrically connected via a second electric line, wherein the second electric line extends substantially parallel to the driven shaft of the electric motor.

9. The actuator assembly according to claim 1, wherein the partition panel and the circuit board are connected via a potting material, at least in part.

10. The actuator assembly according to claim 1, wherein the control assembly comprises a speed regulating unit for regulating a speed of the electric motor and/or a current measuring unit for measuring a current received by the electric motor and/or a power supply unit for supplying the electric motor with electric energy and/or a temperature measuring unit for measuring a temperature within the actuator assembly and/or a force measuring unit for measuring a brake actuating force provided by the actuator assembly and/or a rotational position detection unit for detecting a rotational position of the electric motor and/or an actuating unit for a locking assembly for blocking the driven shaft of the electric motor against rotation.

11. The actuator assembly according to claim 1, wherein a magnet is arranged on an end of the driven shaft of the electric motor which faces the control assembly, and a sensor, which is associated with the magnet, is positioned on the circuit board such that it is substantially opposite the end of the driven shaft.

12. A method for manufacturing an actuator assembly for a vehicle brake, comprising the following steps:
a) providing a substantially shell-shaped housing base part,
b) inserting a drive assembly into the housing base part, which drive assembly comprises a carrier assembly on which an electric motor, a spindle drive and a gear unites are mounted, which gear unit drivingly couples the electric motor and the spindle drive,
c) inserting a control assembly into the housing base part, which control assembly comprises a partition panel and a circuit board fastened to said partition panel, wherein the insertion results in an electrical connection of at least the electric motor and the circuit board, and
d) closing the housing base part with a housing cover.

13. The method according to claim 12, wherein a plug-connector half is integrally provided on the housing and the plug-connector half is electrically connected to the circuit board as a result of inserting the control assembly into the housing base part.

14. The method according to claim 12, wherein the circuit board is electrically connected to the electric motor and/or the plug-connector half by forming an electrical press connection or an electrical insulation displacement connection.

15. The actuator assembly according to claim 3, wherein retaining ribs for a lubricating medium are arranged on a side of the partition panel which faces the drive assembly.

16. The actuator assembly according to claim 7, wherein the electric motor and the circuit board are electrically connected via a second electric line, wherein the second electric line extends substantially parallel to the driven shaft of the electric motor.

17. The actuator assembly according to claim 1, wherein the partition panel and the circuit board are connected via a potting material, at least in part.

18. The actuator assembly according to claim 1, wherein the control assembly comprises a speed regulating unit for regulating a speed of the electric motor and/or a current measuring unit for measuring a current received by the electric motor and/or a power supply unit for supplying the electric motor with electric energy and/or a temperature measuring unit for measuring a temperature within the actuator assembly and/or a force measuring unit for measuring a brake actuating force provided by the actuator assembly and/or a rotational position detection unit for detecting a rotational position of the electric motor and/or an actuating unit for a locking assembly for blocking the driven shaft of the electric motor against rotation.

19. The actuator assembly according to claim 18, wherein a magnet is arranged on an end of the driven shaft of the electric motor which faces the control assembly, and a sensor, which is associated with the magnet, is positioned on the circuit board such that it is substantially opposite the end of the driven shaft.

20. The method according to claim 13, wherein the circuit board is electrically connected to the electric motor and/or the plug-connector half by forming an electrical press connection or an electrical insulation displacement connection.
